(19) United States
(12) Patent Application Publication
(10) Pub. No.: US 2024/0351853 A1
(43) Pub. Date: Oct. 24, 2024

(54) INTERMEDIATE PIECE FOR A LIQUID CONTAINER

(71) Applicant: Robert Maierhöfer GbR, Eppingen (DE)

(72) Inventor: Benjamin Maierhöfer, Eppingen (DE)

(73) Assignee: Robert Maierhöfer GbR, Eppingen (DE)

(21) Appl. No.: 18/640,240

(22) Filed: Apr. 19, 2024

(30) Foreign Application Priority Data
Apr. 20, 2023 (EP) 23168921.7

(51) Int. Cl. B67D 1/08

(52) U.S. Cl. CPC B67D 1/0801

(57) ABSTRACT

The present invention relates to an intermediate piece (24) for connecting a liquid container (18) to a beverage dispensing outlet (10), including: a lower portion (36) for coupling to a connecting piece (28) of the liquid container; and an upper portion (34) for coupling to a valve piece (26), wherein the intermediate piece (24) is designed as a rigid component without movable parts. The invention further relates to a valve piece (26) for connecting a liquid container (18) to a beverage dispensing outlet (10), a closure system (22), and a liquid container (18).

The present invention relates to an intermediate piece for connecting a liquid container to a beverage dispensing outlet. The present invention further relates to a valve piece for connecting a liquid container with a beverage dispensing outlet as well as to a closure system and a liquid container.

Beverage dispensing outlets are used, for example, in restaurants, bars, on cruise ships or in cinemas in order to make beverages easily available. Soft drinks or fruit juices in particular may be dispensed in this manner and are usually filled directly into glasses or cups. The filling can be done by the consumers or by staff members. In such beverage dispensing outlets syrup or another liquid is usually used and, on demand, dispensed together with water and, where appropriate, carbon dioxide. Mixing the beverages on the spot makes it possible to reduce the quantities that have to be transported. In other words, the beverages are prepared on the spot by mixing them with water and, if appropriate, by adding carbon dioxide, so that only the syrup has to be transported to the place of consumption.

For this purpose, liquid bags are usually used as liquid containers, which are connected, to the beverage dispensing outlet via tube systems. The actual mixing with water is made in the beverage dispensing outlet. The closure of such liquid containers enables both efficient filling of the liquid container in a filling plant and efficient dispensing at the beverage dispensing outlet. In this context, closures are often used in which a connecting piece, known as a fitting, is inserted into a liquid container, for example by means of a bonding or welding process. Once the liquid container has been filled, a valve can then be inserted or pressed or clicked into this fitting, thus creating a liquid-tight connection for transporting the liquid container. This valve ensures the connectibility of the container to the beverage dispensing outlet. For this purpose, a dedicated tube can, for example, be connected to the valve by means of an appropriate connector, with the valve being pressed open during connection.

The manufacture of these valves is relatively complex, as in addition to the manufacture of an injection-moulded base body, a push rod and a spring are often required for ensuring a proper valve function. Such a push rod and such a spring are typically made from other materials and, therefore, require an assembly operation. A side effect in this context is that different materials have to be disposed of when the used, valve-equipped liquid containers are being disposed of. For example, in addition to a liquid bag and an injection-moulded part of the valve, both of which can be made from polyethylene, a metal part for the spring and another plastic material for other valve components can also be necessary. Recycling then often involves material separation, which can lead to high effort and higher costs. Moreover, it can result in infringement of legal regulations or voluntary commitments on the part of the beverage suppliers.

On this basis, it is the object of the present invention, in this context, to provide an approach for connecting a liquid container to a beverage dispensing outlet which, on the one hand, is compatible with existing systems and devices and, on the other hand, enables efficient manufacturing and/or efficient disposal or reuse. The object consists in particular in providing an approach that requires only minor or no adjustments to installed beverage dispensing outlets and to established processes on the part of beverage suppliers and users. An additional object is to simplify the recycling of packaging materials.

To meet this object, the present invention, in one aspect, relates to an intermediate piece for connecting a liquid container to a beverage dispensing outlet, including:
a lower portion for coupling to a connecting piece of the liquid container; and
an upper portion for coupling to a valve piece, wherein
the intermediate piece is designed as a rigid component without movable parts.

In a further aspect, the present invention relates to a valve piece for connecting a liquid container to a beverage dispensing outlet, including:
a coupling portion for coupling to an intermediate piece, in particular as defined above;
a connecting portion for coupling to the beverage dispensing outlet; and
a valve arrangement for preventing liquid from escaping from the liquid container when the valve arrangement is in a closed state, the valve arrangement preferably comprising a journaled push rod and a spring, in particular a metal spring, for exerting force on the push rod.

In addition, an aspect of the present invention relates to a closure system for connecting a liquid container to a beverage dispensing outlet, said closure system including an intermediate piece as described above and a valve piece as described above.

Finally, one aspect of the invention relates to a liquid container including an intermediate piece or a closure system as described above.

Preferred configurations of the invention will be described in the dependent claims. It is to be understood that the features mentioned above and those yet to be explained further down may not only be used in their respectively specified combination, but also in other combinations or alone without departing thereby from the scope of the present invention. In particular, the intermediate piece, the valve piece, the closure system and the liquid container can be designed in accordance with the embodiments for the intermediate piece and the valve piece as described in the dependent claims.

According to the invention, provision is made for using an intermediate piece which connects the connecting piece of the liquid container to a valve piece. The valve piece and/or the valve itself is therefore no longer connected directly to the connecting piece of the liquid container, but is coupled to an intermediate piece. In this respect, the previous two-part design consisting of a connecting piece arranged on the liquid container and a valve is replaced by a three-part design consisting of a connecting piece arranged on the liquid container, an intermediate piece, and a valve piece. This three-part design allows the individual components to be coupled in such a manner that the valve piece can be reused as a separate component. Since the intermediate piece according to the invention is designed as a rigid component without movable parts, it may be disposed of in an easy manner. A rigid component without movable parts is defined, in particular, as a component that can be manufactured by injection moulding without requiring further assembly steps. The intermediate piece does not contain the movable components required for the function of a valve and can therefore be disposed of without having to be disassembled. Thus, the resulting waste is homogeneous. The valve piece according to the invention can be reused several times. For its disposal the valve piece can either be disassembled or it be disposed of as a mixed-substance component consisting of several parts made from different materials, said disposal being a simplified solution in so far as the valve piece represents a significantly reduced amount of material that has to be disposed of as compared to a liquid container having an irreversibly connected valve. The amount of mixed-substance waste material produced is thus significantly reduced.

The intermediate piece according to the invention is essentially constructed in two parts, comprising a lower portion and an upper portion. The lower portion is used to couple or connect the intermediate piece to a connecting piece of the liquid container. The resulting connection is preferably a snap-in connection or an irreversible connection which, once established, cannot be released again in a non-destructive manner. In contrast, the coupling to the valve piece provided in the upper portion of the intermediate piece is preferably a reversible connection that can be released again in a non-destructive manner, at least with regard to the valve piece.

Compared to previous approaches, this offers advantages in terms of manufacturing complexity, so that cost benefits can be realised. Furthermore, there are advantages in terms of disposability, so that legal regulations or self-imposed regulations on the part of suppliers can be better complied with. Thus, it is possible, in particular, to improve the recyclability and thus the sustainability.

In a preferred configuration, the intermediate piece consists of exactly one single material, in particular polyethylene. Preferably, the intermediate piece can be manufactured by injection moulding. The use of polyethylene makes it suitable for use in the food sector. In addition, it can be easily disposed of. Manufacturing by injection moulding ensures efficient manufacturability. Moreover, the costs are reduced.

In a preferred configuration, the upper portion has a cylindrical structure extending along a longitudinal axis and preferably it has a diameter that is smaller than the diameter of a cylindrical accommodating section of the valve piece, so that said upper portion can be received in the accommodating section of the valve piece. Said longitudinal axis is, in particular, an axis of symmetry that runs longitudinally through the lower portion and the upper portion. A cylindrical structure enables easy coupling to corresponding coupling systems of a tube. In addition, this results in efficient manufacturability. The accommodating section of the valve piece can be designed in particular for receiving the upper portion of the intermediate piece by way of a click-in connection or by an insertion/latching mechanism. For example, corresponding projections and depressions on both components involved can be used to enable clicking and latching that cannot be released in a non-destructive manner. The result is efficient manufacturability and efficient usability.

In a preferred configuration, the intermediate piece comprises a fastening element arranged in the upper portion for reversibly fastening the valve piece to the intermediate piece, preferably by a relative rotation between the valve piece and the intermediate piece, in particular a relative rotation about a longitudinal axis of the intermediate piece. The fastening element is preferably arranged in a region of the upper portion located adjacently to the lower portion. The fastening element enables the valve piece to be detachably fastened to the intermediate piece. The valve piece can, for example, be secured to the intermediate piece by a rotary movement. Typically, the intermediate piece is irreversibly connected to the connecting piece of the liquid container at the time of filling. The valve piece can then be secured to the intermediate piece for connection to the beverage dispensing outlet. Securing the fastening element itself may, for example, require relative rotation thereof around a longitudinal axis of the intermediate piece. Relative rotation allows easy fastening, so that handling is made simple for the operator.

In a preferred configuration, the fastening element comprises a radial projection formed in an outer circumference of the upper portion which is configured to co-act together with an accommodation recess formed in a circumference or inner circumference of the valve piece. The projection preferably comprises a hook for latching with a corresponding counter-hook of the accommodation recess of the valve piece. The radial projection in the outer circumference of the upper portion acts together with an accommodation recess to enable the valve piece to be fixed to the intermediate piece. The radial projection enables the valve piece and the intermediate piece to be fixed to each other in particular by relative rotation. This can be easily realised by using a hook that is related to a counter-hook. This results in both efficient manufacturability and easy usability.

In a preferred embodiment, two combinations of fastening element and accommodation recess offset by 180° in the circumferential direction can be provided on the intermediate piece and on the valve piece, respectively. There are two fastening elements on the intermediate piece and two accommodation recesses on the valve piece. This results in stronger coupling and thus prevents fluid leakage.

In a preferred configuration, the intermediate piece comprises a further circumferential, radial projection arranged in the lower portion. The radial projection is designed to secure the accommodation recess of the valve piece between the radial projection and the further circumferential, radial projection. Thus, the circumferential, radial projection acts as a kind of bearing or stop for the valve piece. The valve piece is clamped between the radial projection and the further circumferential, radial projection. This results in both efficient manufacturability and easy usability.

In a preferred configuration, the lower portion has a cylindrical structure extending along a longitudinal axis and, in particular, having a diameter that is smaller than the diameter of a cylindrical accommodating section of the connecting piece. In this way, the lower portion can be accommodated in the accommodating section or within the accommodating section of the connecting piece. Additionally, or alternatively, when in a coupled state, the lower portion protrudes beyond the connecting piece and into the liquid container. A cylindrical structure extending along a longitudinal axis, which again preferably corresponds to a central axis of symmetry running through the lower portion and the upper portion, ensures simple manufacturability. It is also easy to use, as the lower portion may be received regardless of any given rotation position. The lower portion may, as it were, be slid into the accommodating section of the connecting piece. This results in simple connectibility. Since the lower portion protrudes into the liquid container, efficient dispensing of liquid from the liquid container can be ensured. Blockage of the flow passage is avoided.

In a preferred configuration, the intermediate piece comprises a circumferential, radial protrusion arranged in the outer circumference of the lower portion and/or a circumferential, radial depression arranged in the outer circumference of the lower portion, which serves for coupling to a corresponding depression and/or a corresponding protrusion arranged in an inner circumference of the accommodating section of the connecting piece. The interaction between said protrusion and said depression allows for easy fixing by pressure-insertion. Thus, the intermediate piece is fixed in the connecting piece by reversible deformation of the material. The intermediate piece can be clicked into the connecting piece. The connection is preferably irreversible and cannot be released in a non-destructive manner. On the one hand, this enables efficient manufacturability. On the other hand, it also ensures easy usability.

In a preferred configuration, the intermediate piece comprises a closure for blocking a connection between the liquid container and the beverage dispensing outlet in the unopened state. The closure is preferably designed for being irreversibly opened by a spike extension of the valve piece, in particular when the valve piece and the intermediate piece are used for the first time. Further preferably, the closure is so arranged in the upper portion of the intermediate piece that it faces the valve piece. The closure makes it possible for the intermediate piece to be fixed to the connecting piece of the liquid container after the latter has been filled in order to close the liquid container in this way. Thus, the liquid container is filled via the connecting piece and closed by means of the intermediate piece. Liquid leakage from the intermediate piece is prevented by the closure. The closure is only opened when liquid is to be dispensed and, in particular, when the valve piece is connected to the intermediate piece, so that the outflow of liquid is then only prevented by the valve itself. The valve, in turn, is only opened to draw liquid when it is used in the beverage dispensing outlet to allow the liquid to flow into the beverage dispensing outlet. This results in simple operability and efficient manufacturability.

In a preferred configuration of the valve piece, the coupling portion has a cylindrical structure extending along a longitudinal axis. Preferably, the coupling portion has a diameter that is larger than the diameter of an upper portion of the intermediate piece, so that the coupling portion, in its interior, forms a cylindrical accommodating section for receiving the intermediate piece. Accordingly, the valve piece has a design corresponding to the intermediate piece, so that an accommodation recess formed in the coupling portion of the valve piece receives the intermediate piece by surrounding or embracing it. The fact that the diameter in the region of the valve piece is larger than the diameter in the region of the intermediate piece ensures unhindered flow passage of the liquid and improved tightness. Thus, there are no edges in the area in which liquid flows from the liquid container towards the valve. This makes the elements simply couplable while still providing the relevant function.

In a preferred configuration of the valve piece the valve piece comprises an accommodation recess, arranged in the coupling portion, for a fastening element of the intermediate piece which is configured for reversibly fastening the valve piece to the intermediate piece, preferably by a relative rotation between the valve piece and the intermediate piece, in particular a relative rotation about a longitudinal axis of the valve piece. Additionally or alternatively, the valve piece comprises a spike extension for irreversibly opening a closure of the intermediate piece, preferably in case of initial connection between the valve piece and the intermediate piece, wherein the spike extension is realised, in particular, as an axially extending projection formed in the accommodating section of the valve piece. Additionally or alternatively, the valve piece comprises a circumferential, radial protrusion arranged in the connecting portion and a circumferential, radial depression arranged in the connecting portion for interacting with a coupler ensuring coupling to the beverage dispensing outlet. The accommodation recess for the fastening element of the intermediate piece can, for example, comprise a kind of counter-hook for a hook serving as the fastening element of the intermediate piece. The hook and the counter-hook can relate to each other, so that hook engagement can cause the hook to be secured in position. The relative rotation therefore causes hook engagement with an accommodation recess designed as a counter-hook in the coupling portion of the valve piece. It is particularly advantageous if a relative rotation can be used for connecting or coupling. This ensures easy handling for any coupling and uncoupling operations between the valve piece and intermediate piece. The closure of the intermediate piece can be opened by the spike extension. For example, a kind of predetermined breaking point can be provided on the intermediate piece, which is then opened by the spike extension. When the valve piece is initially connected to the intermediate piece, the spike extension can break this predetermined breaking point, allowing fluid to enter the valve piece through the intermediate piece. The valve arrangement in the valve piece blocks the outflow of liquid until the liquid container is connected to the beverage dispensing outlet, for example by a corresponding tube or tube connection. This makes it possible to manufacture and deliver the liquid container with the connecting piece and the intermediate piece attached thereto without any liquid leaking out. This results in easy handling and lower production costs as usually no extra valve piece or valve has to be supplied. A circumferential, radial protrusion and a circumferential, radial depression can be used to ensure coupling to a correspondingly designed counterpart on the beverage dispensing outlet or on a tube of the beverage dispensing outlet. Such depressions and protrusions are common coupling points that can be used, for example, by means of a click-in or snap-in mechanism through stretch and tension, possibly using a spring force. The connecting portion in the valve piece designed in this way ensures compatibility with existing beverage dispensing outlets, so that replacement costs can be reduced. Moreover, there is no need to adapt the beverage dispensing outlet. Consequently, the overall costs can be minimised and the approach according to the invention including the intermediate piece and the valve piece can be implemented in a simple manner.

In a further configuration of the intermediate piece, the intermediate piece comprises a further circumferential, radial projection arranged in the lower portion, which projects at least partially in the radial direction beyond an outer wall of the accommodating section of the connecting piece. The protruding radial projection forms a kind of bearing, making it easy to fix the intermediate piece to the connecting piece. In addition, it becomes easy to manufacture the intermediate piece. This results in reduced costs and in improved handling comfort, possibly also in an automated filling plant in which the connecting piece on the liquid container is closed by inserting, or click-inserting, the intermediate piece.

As used herein, a liquid container is understood to be, in particular, a syrup container for use in soft-drink beverage dispensing outlets or in juice beverage dispensing outlets. Portions denote adjoining sections or subsections. The relative terms top and bottom or upper portion and lower portion are only used for purposes of designation and delimitation. It is understood that the relative position can also be reversed, depending on the orientation of the intermediate piece, and that top and bottom can be reversed in this respect. In this context, coupling means both an irreversible and a reversible connection of two pieces. The coupling or connecting operation creates a fluid connection so that fluid, in particular liquid, can pass from the liquid container into the various constituent parts or through the various constituent parts. Movable components are components that are not rigidly connected and can non-destructively perform a (relevant) relative movement with respect to the remaining main component. Movable components perform relative movements with respect to each other, for example by sliding towards or away from each other.

In the following, the invention will be described and explained in greater detail with reference to a few selected embodiment examples and in connection with the enclosed drawings. In the drawings:

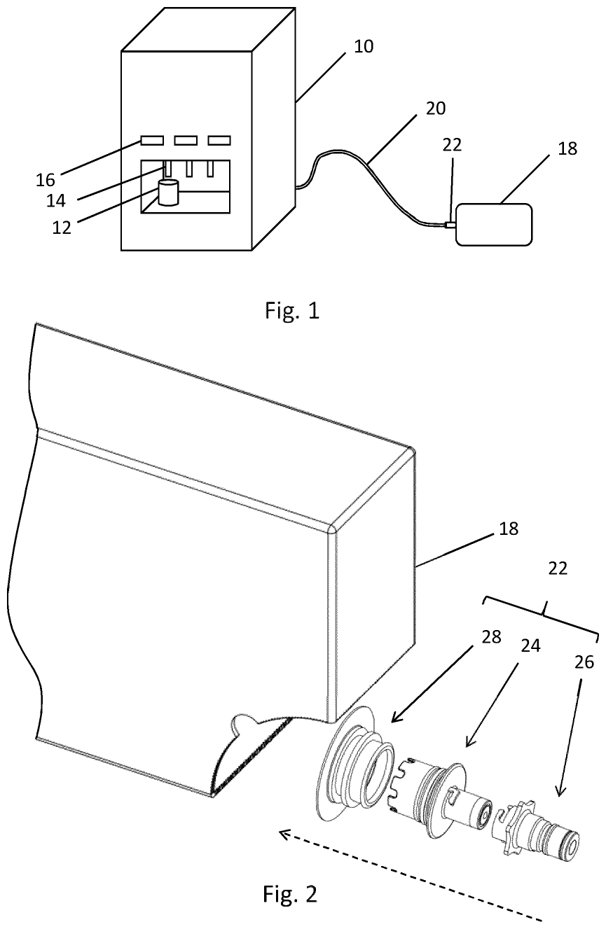

FIG. 1 is a schematic representation of a beverage dispensing outlet including a liquid container with a closure system according to the invention;

FIG. 2 is a schematic representation of the functioning of a closure system according to the invention on a liquid container;

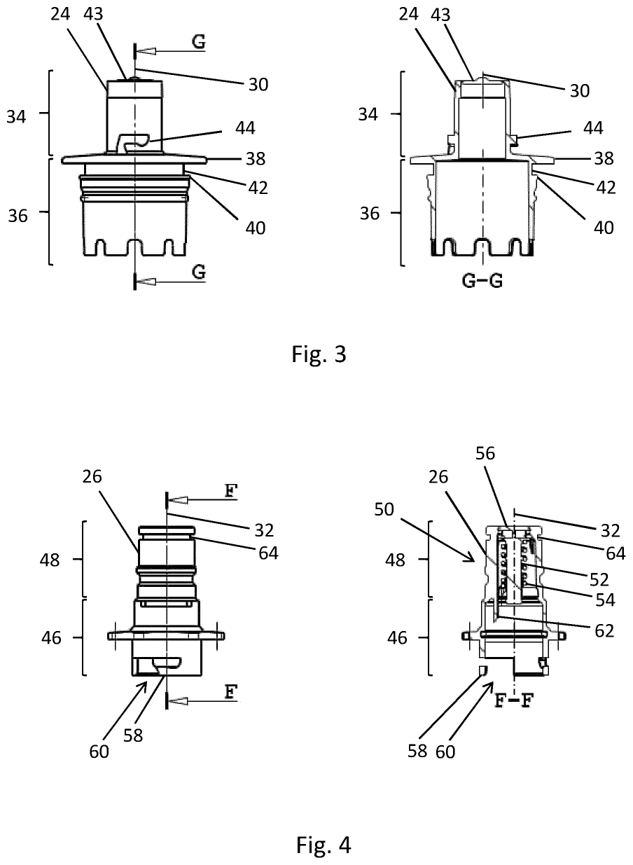

FIG. 3 is a schematic representation of an intermediate piece according to the invention;

FIG. 4 is a schematic representation of a valve piece according to the invention;

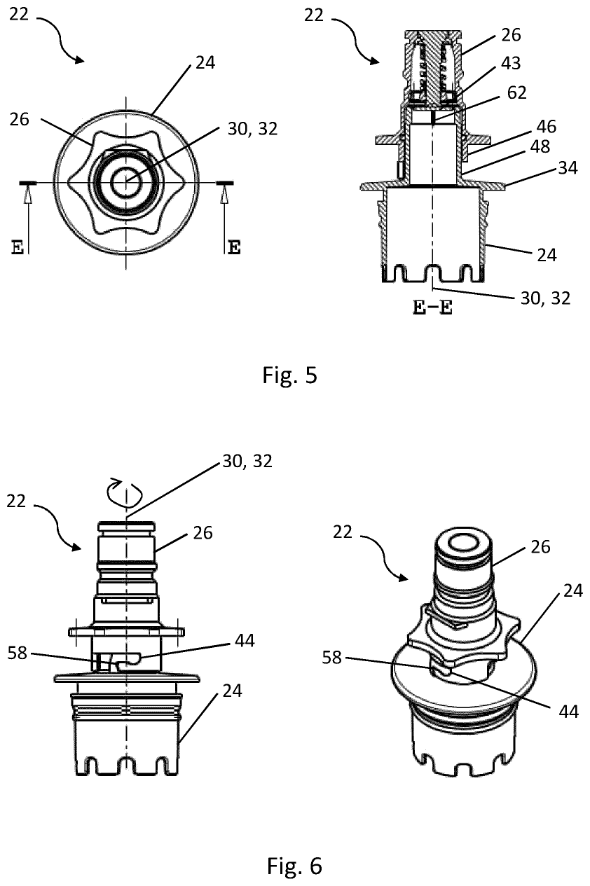

FIG. 5 is a schematic representation of a closure system according to the invention;

FIG. 6 is a further schematic representation of a closure system according to the invention;

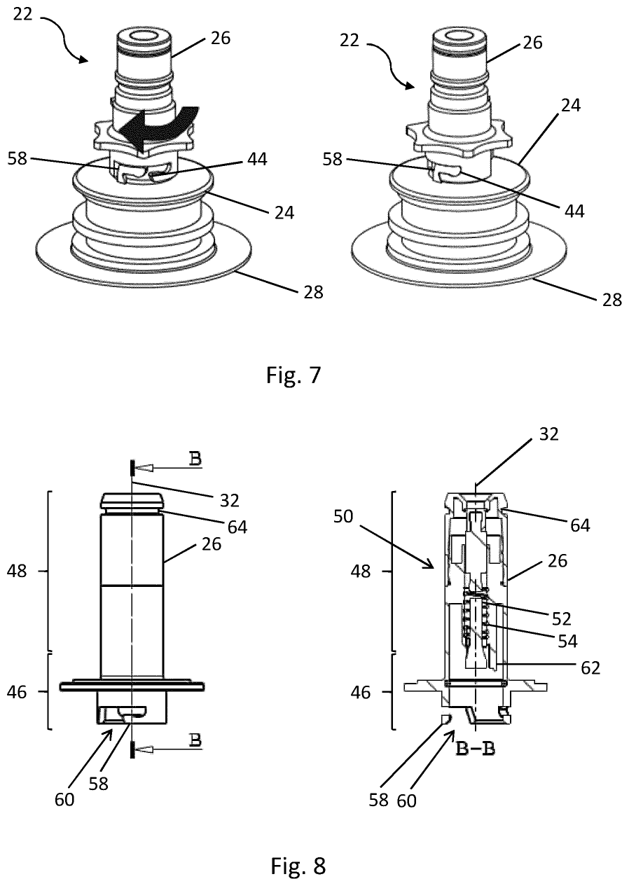

FIG. 7 is a schematic, perspective representation of a closure system according to the invention;

FIG. 8 is a schematic representation of a further embodiment of a valve piece according to the invention; and

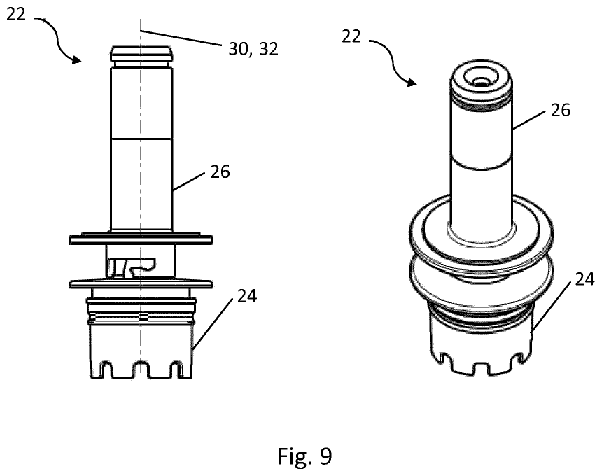

FIG. 9 is a schematic representation of a further embodiment of a closure system according to the invention.

FIG. 1 schematically shows a beverage dispensing outlet 10. Such systems are used, for example, in restaurants, cinemas or also on cruise ships to supply a large number of people with beverages. In the illustrated embodiment example, a beverage receptacle 12 can be placed under a dispensing spout 14. The dispensing of a beverage can then be requested by pressing a button 16. Obviously, other types of operability can also be intended. The beverages to be dispensed may include, for example, soft drinks, juices, and alcoholic beverages. In many cases, both carbonated and non-carbonated beverages may be dispensed.

In beverage dispensing outlets of this type, water is usually mixed with syrup or another liquid preparation means. For example, a mixture can be made in a ratio of 1:3 or less. Mixing with water reduces the amount of material that needs to be supplied as compared to a delivery of finished beverages. The syrup or the beverage raw material in a liquid container 18 is usually connected to the beverage dispensing outlet 10 via a tube 20. Obviously, other types of connections can also be provided. For example, the liquid container 18 may alternatively be suspended in a specially adapted fixture arranged directly within the beverage dispensing outlet 10. In case of a tube connection, the liquid container 18 can, for example, be kept in a specially adapted shelf in a room provided for this purpose. According to the invention, a new closure system 22 is provided for connecting the liquid container 18 to the beverage dispensing outlet 10.

In this context, FIG. 2 schematically illustrates a closure system 22 according to the invention. The illustration is to be understood as a schematic perspective view. The closure system 22 comprises an intermediate piece 24 and a valve piece 26. The intermediate piece 24 is attached to a connecting piece 28 of the liquid container 18. For the sake of clarity, the components are shown separately. The connection between the parts is made in the direction of the dashed arrow. Prior to their utilisation, the components of the closure system 22 are connected to the connecting piece 28 of the liquid container 18. Both the valve piece 26 and the intermediate piece 24 have a structure extending along longitudinal axes (central axes), said longitudinal axes coinciding with each other when the intermediate piece 24 is connected to the valve piece 26.

For filling the liquid container 18 in a filling plant, provision is usually made for the contents to be fed into the liquid container 18 through the connecting piece 28. In prior-art approaches, a valve is then fixed within the connecting piece 28 of the liquid container to seal the liquid container before the liquid container 18 is dispatched for delivery. This valve can then be used to close the liquid container 18 and/or the connecting piece 28. In addition, coupling to a beverage dispensing outlet, for example via a tube and a corresponding counterpart, is made possible.

According to the invention, the valve, which previously consisted of a single piece, is replaced by a two-piece structure consisting of the intermediate piece 24 and the valve piece 26. Due to this two-piece structure, the intermediate piece 24 does not have to provide a valve function, which makes it possible, on the one hand, to realise a configuration consisting of only one material (since different materials required for providing the valve function can be dispensed with) and, on the other hand, to have a configuration without movable components (since a valve function does not have to be provided). This improves the recyclability of the intermediate piece 24. In addition, the valve piece 26 can be reused several times. And finally, compatibility with existing beverage dispensing outlets is maintained.

With the approach according to the invention, the intermediate piece 24 can be used to close the liquid container 18 after filling. The liquid container 18 can then be dispatched in a sealed state and transferred to the place of use. The valve function and the coupling to a beverage dispensing outlet are then only provided at the place of use by coupling the intermediate piece 24 to the valve piece 26.

FIG. 3 schematically illustrates one embodiment of the intermediate piece 24 according to the invention. The left-hand side shows a side view. The right-hand side shows a corresponding sectional view. The intermediate piece 24 comprises in particular an upper portion 34 and a lower portion 36. In the illustrated embodiment, the intermediate piece 24 has a cylindrical structure extending along a longitudinal axis 30. Both the upper portion 34 and the lower portion 36 are cylindrical. The (cylinder) diameter is smaller in the upper portion 34 than in the lower portion 36. The intermediate piece 24 is preferably made from polyethylene and can be produced by injection moulding. The production from polyethylene results in good recyclability.

In the lower portion 36, the intermediate piece 24 comprises a further circumferential, radial projection 38 which serves as a stop when the intermediate piece 24 is connected to the connecting piece. When connecting the intermediate piece 24 to the connecting piece, the intermediate piece 24 is slid into the connecting piece (cf. FIG. 2). A circumferential, radial protrusion 40 and an adjacent circumferential, radial depression 42 are arranged in the outer circumference of the cylindrical lower portion 36, which are designed to enable the intermediate piece 24 to be fixed within the connecting piece. In particular, the circumferential, radial protrusion 40 has at least partially a wedge-shaped cross-section, such that when the intermediate piece 24 is pressed into the connecting piece, an expansion or a deformation and a subsequent relaxation occur when corresponding protrusions/depressions in the inner circumference of the connecting piece are passed. These deformations lead to an interlocking effect. Once the intermediate piece 24 and the connecting piece have been connected, it is no longer possible to detach them in a non-destructive manner. When the liquid container 18 has been filled, it can be sealed by the intermediate piece 24. In the illustrated embodiment example, a closure 43 is provided in the upper portion 34 in order to block a fluid connection. This closure 43 must be opened before liquid can be dispensed.

A fastening element 44 is provided to secure the valve piece to the intermediate piece 24. The fastening element 44 enables reversible fastening of the valve piece to the intermediate piece 24. In the illustrated embodiment example, the fastening element 44 is designed as a hook and arranged in the outer circumference of the upper portion 34. The fastening element 44 is designed as a projection in the radial direction and, in the upper portion 34, protrudes beyond a circumferential surface of the intermediate piece 24. The fastening element is fixed by rotating it around the longitudinal axis 30.

FIG. 4 represents a schematic embodiment of a valve piece 26 according to the invention. In FIG. 4, the left-hand side shows a side view and the right-hand side shows a sectional view of the valve piece 26. In the illustrated embodiment example, the valve piece 26 has a cylindrical structure extending along a longitudinal axis 32. Coupling to an intermediate piece can be made in a coupling portion 46. In a connecting portion 48, coupling can be realised to a corresponding coupler of a beverage dispensing outlet or to a tube provided with a corresponding coupler.

In the illustrated embodiment example, a valve arrangement 50 is located in the connecting portion 48, preventing liquid from escaping from the liquid container as long as the liquid container including the closure system is not connected to the beverage dispensing outlet. The valve arrangement comprises a push rod 52 and a spring 54. The push rod 52 exerts a force on a sealing element 56, causing the latter, which may, for example, comprise a diaphragm, to seal a fluid path. The material of the push rod 52 is typically different from the material of the other components of the valve piece 26. The spring 54 can in particular be a metal spring and thus also comprise a different material.

In its coupling portion 46, the valve piece 26 comprises an accommodation recess 58, which is configured in particular as a counter-hook in the illustrated embodiment example. The accommodation recess 58 enables reception of the fastening element of the intermediate piece. A connection between the valve piece 26 and the intermediate piece can be established, and released again, by a rotation about the longitudinal axis 32.

In the illustrated embodiment example, the valve piece 26 has a diameter in the coupling portion 46 that is larger than the diameter of the upper portion of the intermediate piece. Thus, in its interior the coupling portion 46 can form a cylindrical accommodating section 60 for the intermediate piece.

In the illustrated embodiment example, the accommodating section 60 has a spike extension 62 formed therein. When the valve piece 26 is connected to an intermediate piece, the spike extension 62 enables a closure to be cut at a corresponding point of the intermediate piece. In particular, a kind of predetermined breaking point can be broken through and thus the liquid container can be opened when it is broached while being used for the first time. In the illustrated embodiment example, the spike extension 62 is arranged as an axially extending projection in the accommodating section 60 of the valve piece 26.

In its connecting portion 48, the valve piece 26 also has a depression 64 which is formed in a circumferential surface thereof and is designed for accommodating a sealing ring. The sealing ring enables liquid-tight connection upon coupling to a corresponding accommodation recess 58 of the beverage dispensing outlet or to an accommodation recess 58 formed on a tube of the beverage dispensing outlet.

FIG. 5 shows a schematic sectional view of the closure system 22 according to the invention including an intermediate piece 24 and a valve piece 26. The left-hand side is a sectional view shown orthogonally to the longitudinal axis 30, 32 in the region of the transition between the coupling portion 46 and the connecting portion 48 of the valve piece 26. The right-hand side shows a sectional view along the longitudinal axis 30, 32. The intermediate piece 24 and the valve piece 26 correspond to the embodiments shown in FIGS. 3 and 4. In order to avoid repetition, the features already described in FIGS. 3 and 4 will not be described again.

In FIG. 5, it can be seen in particular in the illustration at the right-hand side that in the connected or coupled state, the upper portion 34 of the intermediate piece 24 engages with the coupling portion 46 of the valve piece 26. A cylinder diameter is thus smaller in the upper portion 34 than in the coupling portion 46. It can also be seen from the illustration that the closure 43 can be pushed open or cut open by the spike extension 62.

FIG. 6 presents further views of the closure system 22. The left-hand side shows a side view. The right-hand side represents a corresponding perspective view. Here, too, the intermediate piece 24 and the valve piece 26 correspond to the embodiments shown in FIGS. 3, 4, and 5.

Especially the function of the connection between the intermediate piece 24 and the valve piece 26 can be seen in FIG. 6. The fastening element 44 of the intermediate piece 24 is received in the accommodation recess 58 of the valve piece 26. The connection can be established (and released again) by a rotational movement about the longitudinal axis 30, 32 (cf. the arrow drawn in the left-hand representation in FIG. 6) through the interaction between the fastening element 44 and the accommodation recess 58. This results in a kind of screwing in. The fastening element 44 and the accommodation recess 58 interact in the form of a hook/counter-hook engagement and thus cause a latching action between the valve piece 26 and the intermediate piece 24.

In particular, deformation of the corresponding material components can be taken advantage of in such a manner that a kind of spring force is used for exerting a securing action. For this purpose, a front region of the fastening element 44 can have a greater extent in a direction parallel to the longitudinal axis 30, 32 than a centre region thereof. A correspondingly shaped depression is formed in the accommodation recess 58. The interaction between the two elements can fix them in position by an interlocking or latching effect.

As indicated at the right-hand side of FIG. 6, two combinations of the fastening element 44 and the accommodation recess 58 angularly offset by 180° in the circumferential direction are provided in the illustrated embodiment example. By using two combinations, the coupling action becomes stronger and liquid leakage can thus be prevented.

FIG. 7 shows a perspective representation of the coupling operation taking place between the intermediate piece 24 and the valve piece 26 in a closure system 22 according to the invention. In the example shown, the intermediate piece 24 is coupled to the connecting piece 28. The arrow in the illustration on the left-hand side visualises the rotary movement to be performed for connecting the two elements. On the right-hand side, a connected state is shown in which the fastening element 44 is engaged with the accommodation recess 58.

FIG. 8 represents an alternative schematic embodiment of a valve piece 26 according to the invention. The valve piece 26 is configured for coupling to another type of coupler of a beverage dispensing outlet. Unlike the embodiment shown in FIG. 4, the embodiment of the valve piece 26 of FIG. 8 is slightly longer in the connecting portion 48 and thus enables coupling with another type of coupler of a beverage dispensing outlet. Essentially, however, the same functionality is provided.

By analogy with the previously illustrated embodiment in FIG. 4, the valve piece 26 of FIG. 8 comprises a coupling portion 46 to be coupled to an intermediate piece and a connecting portion 48 to be coupled to the beverage dispensing outlet. The coupling portion 46 has an accommodation recess 58 provided therein, which corresponds to the fastening element of the intermediate piece. The embodiment of the valve piece 26 in FIG. 8 also has an essentially cylindrical structure extending along a longitudinal axis 32. The various components of the valve arrangement 50 are provided inside the connecting portion 48. The valve arrangement 50 according to the illustrated embodiment example comprises a push rod 52 and a spring 54. There is an accommodating section 60. The illustration in FIG. 8 also shows a circumferential depression 64 which can house a sealing ring. Moreover, a spike extension 62 is provided.

By analogy with FIG. 6, FIG. 9 shows a schematic representation of the second embodiment of the closure system 22, with the valve piece 26 and the intermediate piece 24 in the coupled state. The intermediate piece 24 has a structure extending along a longitudinal axis 30 and corresponds to the intermediate piece shown in FIG. 3. The valve piece 26 has a structure extending along a longitudinal axis 32 and corresponds to the valve piece shown in FIG. 8.

The invention has been comprehensively described and explained with reference to the drawings and the description. The description and the explanation are to be understood as exemplary and not restrictive. The invention is not limited to the disclosed embodiments. Other embodiments or variations will become apparent to a person skilled in the art when using the resent invention and when thoroughly analysing the drawings, the disclosure, and the following claims.

In the claims, the words “comprising” and “with/having” do not exclude the presence of further elements or steps. The indefinite article “a” or “an” used in connection with a word does not exclude the existence of a plurality of the items in question. A single element or a single unit can perform the functions of several of the units mentioned in the patent claims. The mere mention of some measures in several different dependent patent claims is not to be understood as meaning that a combination of these measures cannot also be used advantageously. Reference signs in the patent claims are not to be understood restrictively.

### REFERENCE SIGNS

10 beverage dispensing outlet
12 beverage receptacle
14 dispensing spout
16 button
18 liquid container
20 tube
22 closure system
24 intermediate piece
26 valve piece
28 connecting piece
30 longitudinal axis of the intermediate piece
32 longitudinal axis of the valve piece
34 upper portion
36 lower portion
38 further circumferential, radial projection
40 radial protrusion
42 radial depression
43 closure
44 fastening element
46 coupling portion
48 connecting portion
50 valve arrangement
52 push rod
54 spring
56 sealing element
58 accommodation recess
60 accommodating section
62 spike extension
64 depression

1-15. (canceled)

16. Intermediate piece for connecting a liquid container to a beverage dispensing outlet, the intermediate piece including:
a lower portion for coupling to a connecting piece of the liquid container; and
an upper portion for coupling to a valve piece, wherein the intermediate piece is a rigid component without movable parts.

17. The intermediate piece of claim 16, wherein the intermediate piece consists of exactly one single material, in particular polyethylene, and can preferably be produced by injection molding.

18. The intermediate piece of claim 17, wherein the intermediate piece can be produced by injection molding.

19. The intermediate piece of claim 16, wherein the upper portion has a cylindrical structure extending along a longitudinal axis.

20. The intermediate piece of claim 19, wherein the cylindrical has a diameter that is smaller than the diameter of a cylindrical accommodating section of the valve piece, so that said upper portion can be received in the accommodating section of the valve piece.

21. The intermediate piece of claim 16, including a fastening element arranged in the upper portion for reversibly fastening the valve piece to the intermediate piece, preferably by a relative rotation between the valve piece and the intermediate piece, in particular a relative rotation about a longitudinal axis of the intermediate piece.

22. The intermediate piece of claim 21, wherein the fastening element is arranged in a region of the upper portion located adjacently to the lower portion.

23. The intermediate piece of claim 21, wherein
the fastening element comprises a radial projection formed in an outer circumference of the upper portion which is configured to act together with an accommodation recess formed in a circumference or inner circumference of the valve piece; and
the projection preferably comprises a hook for latching with a corresponding counter-hook of the accommodation recess of the valve piece.

24. The intermediate piece of claim 23, including a further circumferential, radial projection arranged in the lower section, wherein
the radial projection is designed to fix the accommodation recess of the valve piece between the radial projection and said further circumferential, radial projection.

25. The intermediate piece of claim 16, wherein the lower portion
has a cylindrical structure extending along a longitudinal axis and having, in particular, a diameter that is smaller than the diameter of a cylindrical accommodating section of the connecting piece, so that said lower portion can be received in the accommodating section of said connecting piece; and/or
protrudes beyond the connecting piece and into the liquid container in a coupled state.

26. The intermediate piece of claim 25 further including a circumferential, radial protrusion and/or a circumferential, radial depression arranged in the outer circumference of the lower portion and designed for coupling to a corresponding depression and/or a corresponding protrusion formed in an inner circumference of the accommodating section of the connecting piece.

27. The intermediate piece of claim 16 further including a closure for blocking a connection between the liquid container and the beverage dispensing outlet when in an unopened state.

28. The intermediate piece of claim 27, wherein
the closure is designed for being irreversibly opened by a spike extension of the valve piece, in particular when the valve piece and the intermediate piece are connected for the first time; and/or
the closure is arranged in the upper portion of the intermediate piece in a manner so as to face the valve piece.

29. A valve piece for connecting a liquid container to a beverage dispensing outlet, including:
a coupling portion for coupling to an intermediate piece as claimed in claim 16;
a connecting portion for coupling to the beverage dispensing outlet; and
a valve arrangement for preventing liquid from escaping from the liquid container when the valve arrangement is in a closed state.

30. The valve piece of claim 29, wherein the valve arrangement comprises a journaled push rod and a spring, in particular a metal spring, for exerting force on the push rod.

31. The valve piece of claim 29, wherein the coupling portion has a cylindrical structure extending along a longitudinal axis and preferably having a diameter that is larger than the diameter of an upper portion of the intermediate piece, so that the coupling portion forms a cylindrical accommodating section for the intermediate piece in its interior.

32. The valve piece of claim 25, further including
an accommodation recess), arranged in the coupling portion, for a fastening element of the intermediate piece which is configured for reversibly fastening the valve piece to the intermediate piece, preferably by a relative rotation between the valve piece and the intermediate piece, in particular a relative rotation about a longitudinal axis of the valve piece;
a spike extension for irreversibly opening a closure of the intermediate piece, preferably in case of an initial connection between the valve piece and the intermediate piece, wherein the spike extension is designed, in particular, as an axially extending projection formed in the accommodating section of the valve piece; and/or
a circumferential, radial protrusion arranged in the connecting portion and a circumferential, radial depression arranged in said connecting portion for interacting with a coupler for coupling to the beverage dispensing outlet.

33. The valve piece claim 27, wherein the valve piece is made from different materials and preferably comprises a sealing ring made from a material different from that of the valve piece.

34. A closure system for connecting a liquid container to a beverage dispensing outlet, including an intermediate piece for connecting a liquid container to a beverage dispensing outlet, including:
a lower portion for coupling to a connecting piece of the liquid container; and
an upper portion for coupling to a valve piece, wherein
the intermediate piece is designed as a rigid component without movable parts, and
a valve piece as claimed in claim 29.

35. A liquid container including a connecting piece, an intermediate piece for connecting a liquid container to a beverage dispensing outlet, including:
a lower portion for coupling to a connecting piece of the liquid container; and
an upper portion for coupling to a valve piece, wherein
the intermediate piece is designed as a rigid component without movable parts or
a closure system as claimed in claim 34.
